(19) United States
(12) Patent Application Publication
(10) Pub. No.: US 2025/0264436 A1
(43) Pub. Date: Aug. 21, 2025

(54) ION-SELECTIVE MEMBRANE, ION-SELECTIVE ELECTRODE, ION SENSOR, AND SPECIMEN TESTING DEVICE

(71) Applicant: CANON MEDICAL SYSTEMS CORPORATION, Otawara-shi (JP)

(72) Inventors: Wataru KUBO, Inagi (JP); Hiroshi SAITO, Kawasaki (JP); Akio MARUYAMA, Ota (JP)

(73) Assignee: CANON MEDICAL SYSTEMS CORPORATION, Otawara-shi (JP)

(21) Appl. No.: 19/055,701

(22) Filed: Feb. 18, 2025

(30) Foreign Application Priority Data
Feb. 20, 2024 (JP) 2024-023892
Dec. 9, 2024 (JP) 2024-214272

(51) Int. Cl. G01N 27/333

(52) U.S. Cl. CPC G01N 27/3335

(57) ABSTRACT

An ion-selective membrane of an embodiment includes a metal porphyrin compound, a polymer, and a membrane solvent. The membrane solvent is a compound that satisfies CLogP≥9. The compound has a benzene ring. The first position of the benzene ring is an alkyl ester group having 5 or more and 19 or less carbon atoms which may have a substituent. At least one of the third, fourth, and fifth positions of the benzene ring is an alkyl ester group having 5 or more and 19 or less carbon atoms which may have the substituent.

### CROSS-REFERENCE TO RELATED APPLICATION

Priorities are claimed on Japanese Patent Application No. 2024-023892, filed Feb. 20, 2024, and Japanese Patent Application No. 2024-214272, filed Dec. 9, 2024, the contents of which are incorporated herein by reference.

### FIELD

Embodiments disclosed in the present specification and drawings relate to an ion-selective membrane, an ion-selective electrode, an ion sensor, and a specimen testing device.

### BACKGROUND

An electrode that selectively responds to a specific ion with electric potential is called an ion-selective electrode (ISE). When an ISE is immersed in a solution, a potential difference corresponding to the activity of a target ion occurs at an interface between an ion-selective membrane and the solution, causing a change in electrode potential. Ion concentration measurement devices (ion sensors) based on this phenomenon are widely used in the fields of physical and chemical industry, agriculture, medicine, food, environment, and the like.

In ion-selective electrodes used in medical specimen testing devices, measurements of sodium ions, potassium ions, and chloride ions are widely performed. Among them, for sodium ions and potassium ions, which are cations, ionophore-type ISEs are widely used, which use an ion-selective membrane (ISM) in which an ion-selective substance called an ionophore is trapped in a matrix mainly consisting of a polymer and a hydrophobic membrane solvent. On the other hand, for chloride ions, which are anions, ion exchanger-type ISEs are often used, which do not have an ionophore as good as sodium ions or potassium ions, but use poorly soluble salt types such as silver-silver chloride electrodes or ion exchange resins or the like with immobilized ammonium salts or the like.

Ionophores for chloride ions are roughly classified into three types, that is, an organometallic type, an organic type, and a metal complex type. Among them, the organometallic type exhibits high chloride ion selectivity, but uses organic mercury, organotin compounds, or the like, and thus is difficult to use from the viewpoint of the toxicity of chemicals. Also, the organic type such as bisthiourea has the problem of low chloride ion selectivity. The metal complex type exhibits high chloride ion selectivity and is relatively likely to be used for chemicals as compared to the organometallic type. In an ISM using the metal complex type as an ionophore, a membrane solvent having hydrophobic and polar sites in a molecule is often used for a membrane solvent for a hydrophobic membrane.

In the above-mentioned ISM in the related art, a metal porphyrin complex is used for an ionophore for chloride ions, and a representative o-nitrophenyl octyl ether (NPOE) is used for a membrane solvent. The present inventors have researched characteristics of an ISE using a metal porphyrin complex and an NPOE, and confirmed that it exhibits high chloride ion selectivity. On the other hand, the present inventors have found that, when an ISM containing an NPOE is immersed in an aqueous solution containing protein, an electromotive force response to an ion concentration decreases.

An ion-selective membrane of an embodiment includes a metal porphyrin compound, a polymer, and a membrane solvent. The membrane solvent satisfies CLogP≥9 and includes a compound represented by the following general formula (1).

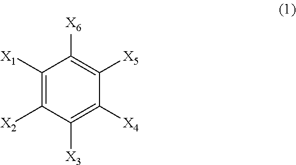

In the general formula (1), X₁ is an alkyl ester group having 5 or more and 19 or less carbon atoms which may have a substituent. X₂ to X₆ are each independently a hydrogen atom or a monovalent substituent. At least one of X₃, X₄, and X₅ is an alkyl ester group having 5 or more and 19 or less carbon atoms which may have the substituent.

In addition, the alkyl ester group having 5 or more and 19 or less carbon atoms which may have the substituent in the present application is an alkyl ester group having 5 or more and 19 or less carbon atoms, excluding carbon atoms of the substituents.

### BRIEF DESCRIPTION OF THE DRAWINGS

FIG. 1 is a schematic diagram for illustrating an overview of an ISE.

FIG. 2 is a schematic diagram for illustrating an overview of an ISM.

FIG. 3 is a graph showing a relationship between CLogP of a membrane solvent and effects of protein on the ISM.

FIG. 4 is a schematic diagram for illustrating an overview of an ion sensor using the ISM.

FIG. 5 is a schematic diagram for illustrating an overview of a specimen testing device.

### DETAILED DESCRIPTION

An ion-selective membrane, an ion-selective electrode, an ion sensor, and a specimen testing device of embodiments will be described below with reference to the drawings.

### Overview

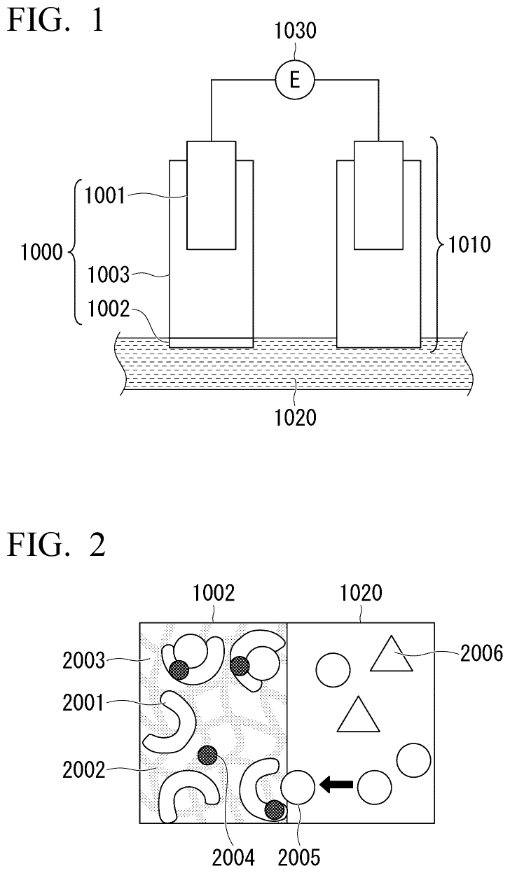

FIG. 1 is a schematic diagram for illustrating an overview of an ion-selective electrode (ISE) 1000 provided with an ion-selective membrane (ISM) 1002 of the present embodiment. In FIG. 1, the ISE 1000 is configured of, for example, an electrode 1001 configured of a conductor, and the ISM 1002. The ISE 1000 may have an internal electrolyte 1003.

The ISE 1000 is disposed in contact with a measurement solution 1020 together with a reference electrode 1010 serving as a comparison target. The reference electrode 1010 may be in contact with the measurement solution 1020 through a salt bridge or liquid junction. In the ISM 1002 in contact with the measurement solution 1020, a membrane potential (E_{M}) proportional to a logarithm of a concentration (more precisely, activity a_{I}(aq)) of a target ion in the measurement solution 1020 is generated. The membrane potential (E_{M}) can be determined by referring to the Nernst equation (eq. 1) below.

$${E}_{M} = {E}^{0} + \frac{RT}{zF} ln {a}_{I} ( aq ) \qquad ( eq . 1 )$$

Here, E⁰ is the standard electrode potential, R is the gas constant, T is the absolute temperature, z is the number of electric charges of the ion, and F is the Faraday constant. In the ion sensor, a potential difference between the ISM and the reference electrode is measured with a voltmeter for a solution with a known concentration of the target ion and the measurement solution, and thus a target ion concentration in the measurement solution is calculated. Each constituent element shown in FIG. 1 will be specifically described below.

### Ion-Selective Electrode (ISE)

The ISE 1000 of the present embodiment is configured of the electrode 1001 configured of at least one type of conductor and the ISM 1002. A publicly known structure can be used for a structure of the ISE 1000. Examples thereof include a structure in which the internal electrode 1001 is in contact with the internal electrolyte 1003, the internal electrolyte 1003 is in contact with the ISM 1002, and the ISM 1002 is in contact with the measurement solution 1020, as shown in FIG. 1.

A publicly known configuration can be used for a configuration of the ISE 1000 other than the ISM 1002. Examples of the materials of a cylindrical body of the ISE 1000 include polymers such as polyvinyl chloride and polymethyl methacrylate. Examples of the internal electrolyte 1003 include aqueous solutions of sodium chloride, potassium chloride, and the like. Examples of the internal electrode 1001 include electrodes made of metal/poorly-soluble metal chloride such as silver-silver chloride, and electrodes made of conductive materials such as platinum, conductive carbon materials, or conductive polymers. In addition, a solid-type ISE 1000 in which the internal electrolyte 1003 is omitted and the ISM 1002 is applied to the electrode 1001 made of a conductor is also preferably used.

The ISE 1000 can be used, for example, in the manner shown in FIG. 1. Specifically, it is disposed in contact with the measurement solution 1020 together with the reference electrode 1010. The reference electrode 1010 may be in contact with the measurement solution 1020 through a salt bridge or liquid junction. A publicly known electrode can be used for the reference electrode 1010. Specific examples thereof include electrodes made of metal/poorly-soluble metal chloride such as silver-silver chloride; and electrodes made of conductive materials such as conductive carbon materials, conductive polymers, or platinum.

### Ion-Selective Membrane (ISM)

The ISM of the present embodiment includes a metal porphyrin compound, a polymer, and a membrane solvent. FIG. 2 is a schematic diagram for illustrating an overview of the ISM 1002 of the present embodiment. The ISM 1002 includes an ionophore 2001, a polymer 2002, and a membrane solvent 2003. Also, the ISM 1002 may include an ionic additive 2004. The ionophore 2001 enables generation of an ion-selective membrane potential by selectively taking in target ions 2005 into the ISM 1002 from the measurement solution 1020 containing the target ions 2005 and impurity ions 2006 (the process indicated by the arrow in the figure).

A publicly known method can be used for a production method of the ISM 1002. An example thereof will be described below. The ionophore 2001, the polymer 2002, the membrane solvent 2003, and the ionic additive 2004 are dissolved in a process solvent, and the resultant solution is cast on a substrate such as a glass plate and left to stand still. After the process solvent volatilizes, the ISM 1002 is molded into a desired shape. For the process solvent, a solvent that can dissolve the components of ISM 1002 at a concentration that allows film formation and is suitable for film formation is preferably used. Examples thereof include tetrahydrofuran, chloroform, acetone, methyl ethyl ketone, toluene, ethyl acetate, and the like. A film thickness of the ISM 1002 can be adjusted by controlling an amount of process solvent, or the like. An appropriate film thickness thereof varies depending on the mechanical strength and cost of an intended use, but a thickness of 1 μm or more and 5 mm or less can be exemplified therefor. The components included in the ISM 1002 will be described below.

### Membrane Solvent

The ISM 1002 of the present embodiment includes the membrane solvent 2003. The membrane solvent 2003 is the component that often has the largest mass ratio among the components included in the ISM 1002. The membrane solvent 2003 forms a flexible matrix together with the polymer 2002. The matrix retains other components such as the ionophore 2001 therein to cause the ISM 1002 to function. Since the measurement solution 1020 is usually an aqueous solution, the membrane solvent 2003 of the ISM 1002 has a hydrophobicity that allows it to retain the components of the ISM 1002 so that they do not dissolve into the membrane. On the other hand, the membrane solvent 2003 preferably has a polarity sufficient to retain the ionophore 2001 and the ionic additive 2004 well, which have a certain degree of polarity, and to take in the target ions 2005 into the membrane. Among them, for the membrane solvent 2003 suitable for the ISM 1002 using a porphyrin complex as the ionophore 2001, a solvent containing a benzene ring is preferably used to stably retain a highly conjugated porphyrin complex.

NPOE is widely known as a representative membrane solvent. However, when an ISM containing NPOE is immersed in an aqueous solution containing protein, an electromotive force response to an ion concentration decreases.

The present inventors have examined various membrane solvents to solve this problem. Among them, it has been found that dioctyl phthalate (DOP), which has a relatively small polarization and multiple hydrophobic alkyl chains, exhibits relatively good characteristics. However, there has been a demand for improving durability in repeated measurements of ion concentration of test solutions containing high concentrations of protein.

The present inventors have researched the cause of the decrease in electromotive force response due to the influence of protein. In order to inhibit the effect of protein in bio-related devices, a method is known in which a device surface is made hydrophilic to inhibit protein adsorption. However, the method of making a surface of an ion-selective membrane hydrophilic was not effective for an ISM that uses a porphyrin complex as an ionophore. The present inventors have performed further research and found that the cause of the decrease in electromotive force response due to the effect of protein is an unclear interface between a hydrophobic membrane and an aqueous solution due to a surfactant function of the protein, which results in the infiltration of counter ions and a reduction in the potential difference. As a measure to avoid the decrease in electromotive force response due to this cause, the present inventors have tried to form a hydrophobic membrane that can inhibit the effect of the surfactant function of the protein by improving the membrane solvent. As specific measures, the following two methods have been proposed and verified, and the present invention has been completed.

The first method is to strengthen an intermolecular hydrophobic interaction of hydrophobic groups of a membrane solvent. In DOP, two ester groups bonded to a benzene ring are located at adjacent ortho positions. For this reason, the interaction of alkyl chains of the ester groups, which exhibit hydrophobicity of the membrane solvent, is relatively exhibited within molecules, and it is difficult to exhibit the intermolecular interaction that is important as a matrix. In order to strengthen the intermolecular interaction due to the alkyl chains, the ester groups are disposed at a distance from each other to strengthen the intermolecular hydrophobic interaction, thereby forming a hydrophobic membrane that inhibits the influence of a surfactant function of protein.

The second method is to increase intramolecular hydrophobic groups (for example, alkyl groups) of a membrane solvent. In order to form a hydrophobic membrane that can resist a surfactant function of protein, it is effective to improve hydrophobicity of the membrane solvent. One way to achieve this is to increase a proportion of hydrophobic functional groups in molecules. Examples of the hydrophobic functional groups include aromatic functional groups and aliphatic (alkyl chain) functional groups. The present inventors have tested various membrane solvents and found that aliphatic functional groups are advantageous. The following two points can be cited as reasons for this.
(i) Aliphatic functional groups have a higher hydrophobic effect than aromatic functional groups.
(ii) Aromatic functional groups have affinity with a benzaene ring contained in protein through interactions such as ππ conjugation.

For these reasons, it is considered effective to increase a proportion of alkyl groups contained in a carboxylate-based membrane solvent.

The ISM 1002 of the present embodiment satisfies CLogP≥9 and contains a compound represented by the above general formula (1) as the membrane solvent 2003. The compound represented by the above general formula (1) has a benzene ring. The first position (X₁) of the benzene ring is an alkyl ester group having 5 or more and 19 or less carbon atoms. Further, at least one of the third position (X₃), fourth position (X₄), and fifth position (X₅) of the benzene ring is an alkyl ester group having 5 or more and 19 or less carbon atoms.

Here, CLogP is a method using a fragment that is most widely used in the octanol-water partition coefficient LogP, which is the most widely used parameter for describing hydrophilicity and hydrophobicity of a compound. A specific value of CLogP can be simply calculated using commercially available software such as ChemDraw (registered trademark). It is considered that hydrophobicity of molecules increases as the value of CLogP becomes larger. The present inventors have researched and found that compounds satisfying CLogP≥9 show a significant effect in inhibiting the influence of protein.

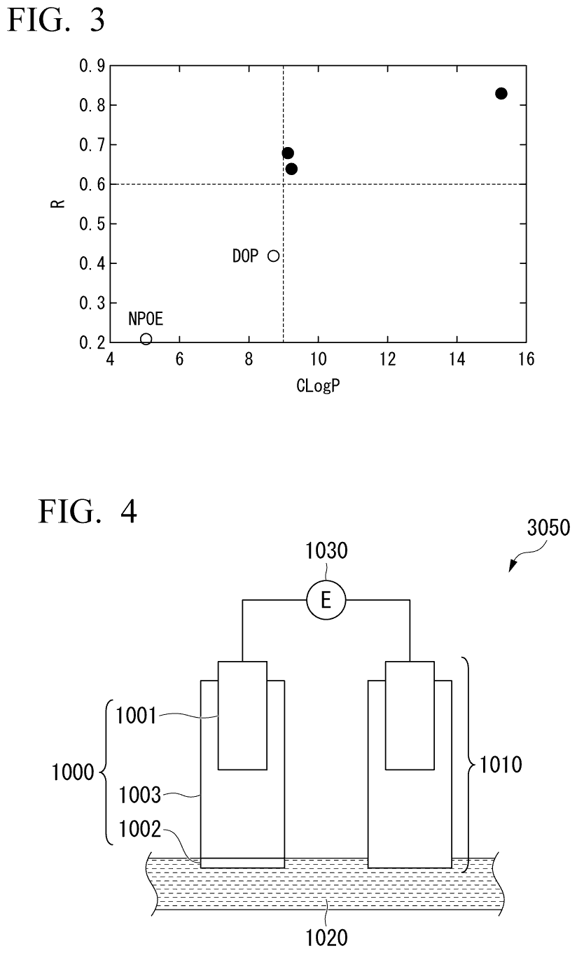

FIG. 3 is a graph showing the relationship between the CLogP of a membrane solvent and effects of protein on the ISM. The horizontal axis of the graph is the CLogP of the membrane solvent. The vertical axis (R) of the graph is a ratio of sensitivity (the electromotive force response to a Cl ion concentration) of the ISE produced using the membrane solvent. This R is, more specifically, a ratio of the sensitivity after a series of measurements in a buffer solution containing protein to the initial sensitivity (the sensitivity after the measurements/the initial sensitivity).

In order to use the ISE as a highly durable ISE in measuring the Cl ion concentration in the solution containing protein, this ratio (R) desirably has a value of 0.6 or more, and more preferably 0.8 or more. In FIG. 3, it can be seen that, when the membrane solvents indicated with the legend of black circles are used, R in the desired range can be obtained. These membrane solvents are compounds that satisfy CLogP≥9 and is represented by the above general formula (1). An upper limit of the CLogP is not particularly limited, but is usually 20.0 or less.

In the above general formula (1), a case in which X₁ is an alkyl ester group and at least one of X₃, X₄, and X₅ is an alkyl ester group corresponds to the above-described first method (strengthening the intermolecular hydrophobic interaction of the hydrophobic groups of the membrane solvent). X₃ and X₅ are in meta positions relative to X₁, and X₄ is in a para position relative to X₁.

X₂ and X₆ may each independently be an alkyl ester group, a substituent that is not an alkyl ester group, or a hydrogen atom. X₂ and X₆ are in ortho positions relative to X₁.

Similarly, in the above general formula (1), a case in which X₁ is an alkyl ester group and at least two of X₂, X₃, X₄, X₅, and X₆ are alkyl ester groups corresponds to the above-described second method (increasing the number of intramolecular hydrophobic groups (alkyl groups) of the membrane solvent).

That is, in the ISM of the present embodiment, the membrane solvent can contain a compound in which X₁, X₂, X₃, X₄, X₅, and X₆ are each selected from the following options.

In the above general formula (1), X₁ is an alkyl ester group having 5 or more and 19 or less carbon atoms which may have a substituent. Also, at least one of X₃, X₄, and X₅ is an alkyl ester group having 5 or more and 19 or less carbon atoms which may have a substituent.

The carbon atoms of the alkyl ester group which may have a substituent is carbon atoms of the alkyl ester group excluding the substituent. That is, in the alkyl ester group which may have a substituent, the substituent portion and the alkyl ester group portion can be distinguished from each other. For example, a branched side chain alkyl group (for example, a 2-ethyl group) in a branched alkyl ester group (for example, a 2-ethylhexyl ester group) does not become a substituent of the alkyl ester group.

The substituents of the alkyl ester groups are preferably each independently selected from the group consisting of an alkoxy group having 1 or more and 4 or less carbon atoms, an alkylcarbonyl group having 2 or more and 5 or less carbon atoms, an alkyloxycarbonyl group having 2 or more and 5 or less carbon atoms, an alkylcarbonyloxy group having 2 or more and 5 or less carbon atoms, an aryl group having 6 or more and 20 or less carbon atoms, a cyano group, and a halogen atom. The carbon atoms of the alkylcarbonyl group, the alkyloxycarbonyl group, and the alkylcarbonyloxy group include the carbonyl group's carbon atoms of 1.

X₂ to X₆ are each independently a hydrogen atom or a monovalent substituent. Here, examples of the monovalent substituent include a saturated or unsaturated alkyl group, an alkoxy group, an alkylcarbonyl group, an aryl group, an aryloxy group, an aralkyl group, a halogen atom, and an alkyl ester group. Two or more of X₂ to X₆ may be bonded to form a ring. For example, two of X₂ to X₆ may be bonded to form a divalent substituent selected from an alkylene group which may have a substituent, an arylene group which may have a substituent, and the like.

X₂ to X₆ are each preferably independently a hydrogen atom, a saturated or unsaturated alkyl group having 1 or more and 20 or less carbon atoms which may have a substituent, an alkoxy group having 1 or more and 20 or less carbon atoms which may have a substituent, an alkylcarbonyl group having 2 or more and 20 or less carbon atoms which may have a substituent, an aryl group having 6 or more and 20 or less carbon atoms which may have a substituent, an aryloxy group having 6 or more and 20 or less carbon atoms which may have a substituent, an aralkyl group having 7 or more and 30 or less carbon atoms which may have a substituent, a halogen atom, or an alkyl ester group having 5 or more and 19 or less carbon atoms which may have the substituent.

The substituents of the alkyl groups are each preferably independently selected from the group consisting of an alkoxy group having 1 or more and 4 or less carbon atoms, an alkylcarbonyl group having 2 or more and 5 or less carbon atoms, an alkyloxycarbonyl group having 2 or more and 5 or less carbon atoms, an alkylcarbonyloxy group having 2 or more and 5 or less carbon atoms, an aryl group having 6 or more and 20 or less carbon atoms, a cyano group, and a halogen atom. The substituents of the alkoxy group, the alkylcarbonyl group, the aryl group, the aryloxy group, and the aralkyl group are preferably each independently selected from the group consisting of a saturated or unsaturated alkyl group having 1 or more and 20 or less carbon atoms, an alkoxy group having 1 or more and 20 or less carbon atoms, an alkylcarbonyl group having 2 or more and 20 or less carbon atoms, an alkyloxycarbonyl group having 2 or more and 20 or less carbon atoms, an alkylcarbonyloxy group having 2 or more and 20 or less carbon atoms, an aryl group having 6 or more and 20 or less carbon atoms, a cyano group, and a halogen atom.

As for arrangement of the alkyl ester groups on the benzene ring, when there are two alkyl ester groups, they may be meta positions (1,3 positions) or para positions (1,4 positions), when there are three alkyl ester groups, they may be 1,2,4 positions or 1,3,5 positions, and when there are four alkyl ester groups, they may be 1,2,3,5 positions or 1,2,4,5 positions.

Among X₂, X₃, X₄, X₅, and X₆, the substituents that are not alkyl ester groups are preferably those whose hydrophobicity constant π of aromatic substituent is 0 or more. Here, the aromatic substituent hydrophobicity constant π is calculated from LogP of monosubstituted benzene. The aromatic substituent hydrophobicity constant π of aromatic substituent is expressed as an increment (logP_{X}-logP_{H}) of a hydrophobicity index (log P) of a compound when a hydrogen atom H is converted to a substituent X at a certain position of a reference substance. π can be considered as a value specific to a substituent. The definition is described in detail in Reference 1 below.
(Reference 1) AKAMATSU Miki, “QSAR parameters and their applications,” Japanese Journal of Pesticide Science, 2013, Vol. 38, No. 2, p. 195-203

The reason why the substituents other than alkyl ester groups are preferably those whose hydrophobicity constant π of aromatic substituent is 0 or more is as follows. In order to inhibit the influence of protein, it is effective to improve the hydrophobicity of the membrane solvent. For that reason, the substituents preferably have the same hydrophobicity constant π of aromatic substituent as that of a hydrogen atom (π is 0) or are more hydrophobic than that (π is greater than 0).

In the alkyl ester group of X₁ and/or at least one of the alkyl ester groups of X₃, X₄, and X₅, each of the alkyl groups of the alkyl ester group may be preferably an alkyl group having 4 or more and 18 or less carbon atoms, may have a substituent, or may be a linear alkyl group or a branched alkyl group. A more preferred alkyl group of the alkyl ester group is an alkyl group having 6 or more and 14 or less carbon atoms (7 or more and 15 or less carbon atoms for the alkyl ester group). A more preferred alkyl group of the alkyl ester group is an alkyl group having 6 or more and 12 or less carbon atoms (7 or more and 13 or less carbon atoms for the alkyl ester group). X₁ is preferably an alkyl ester group having 7 or more and 13 or less carbon atoms which may have a substituent. Also, at least one of X₃, X₄, and X₅ is preferably an alkyl ester group having 7 or more and 13 or less carbon atoms which may have the substituent.

The alkyl group of the alkyl ester group may be a straight-chain alkyl group or a branched alkyl group. Specific examples of the alkyl group of the alkyl ester group, which may be straight-chain or branched, include a butyl group (4 carbon atoms), a pentyl group (5 carbon atoms), a hexyl group (6 carbon atoms), a heptyl group (7 carbon atoms), an octyl group (8 carbon atoms), a nonyl group (9 carbon atoms), a decyl group (10 carbon atoms), an undecyl group (11 carbon atoms), a dodecyl group (12 carbon atoms), a tridecyl group (13 carbon atoms), a tetradecyl group (14 carbon atoms), a pentadecyl group (15 carbon atoms), a hexadecyl group (16 carbon atoms), a heptadecyl group (17 carbon atoms), and an octadecyl group (18 carbon atoms). The alkyl ester group may be an alkyloxycarbonyl group represented by —CO—O—R, where R is the alkyl group.

The alkyl group of the alkyl ester group with larger carbon atoms is more advantageous in improving hydrophobicity. However, if the carbon atoms are too large, it becomes difficult to form a membrane solvent (it becomes solid). If a membrane solvent becomes solid, it may lead to problems such as an increase in noise due to a significant increase in the resistance of an ISM and a decrease in the flexibility of a membrane.

For these reasons, the membrane solvent in the ISM of the present embodiment is preferably a compound represented by any one of the following general formulas (2), (3), and (4).

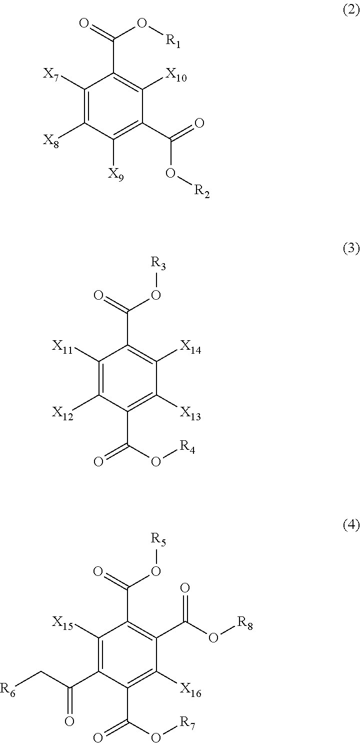

In the above general formulas (2), (3), and (4), X₇ to X₁₆ are each independently a hydrogen atom or a substituent whose hydrophobicity constant π of aromatic substituent is 0 or more. R₁ to R₈ are each independently an alkyl group having 4 or more and 18 or less carbon atoms which may have a substituent. The substituents in R₁ to R₈ are each independently a substituent of the alkyl ester group. R₁ to R₈ may each independently be an alkyl ester group which does not have the substituent.

More preferred membrane solvents include an alkyl ester compound of isophthalic acid, terephthalic acid, or pyromellitic acid. The alkyl ester compound of isophthalic acid is a compound in which X₇ to X₁₀ are all hydrogen atoms in the above general formula (2). R₁ and R₂ may be the same or different. The alkyl ester compound of terephthalic acid is a compound in which X₁₁ to X₁₄ are all hydrogen atoms in the general formula (3). R₃ and R₄ may be the same or different. The alkyl ester compound of pyromellitic acid is a compound in which X₁₅ and X₁₆ are all hydrogen atoms in the general formula (4). R₅, R₆, R₇, and R₈ may be the same or different.

More preferred membrane solvents include bis(2-ethylhexyl) isophthalate (DOIP) alone, bis(2-ethylhexyl) terephthalate (DOTP) alone, tetra(2-ethylhexyl) pyromellitic acid (TOP) alone, or a mixture of two or more of these (that is, a binary mixture of DOIP and DOTP, a binary mixture of DOIP and TOP, a binary mixture of DOTP and TOP, or a ternary mixture of DOIP, DOTP, and TOP).

A composition ratio of the membrane solvent in the ISM can be appropriately selected depending on the use of the ISM. As an example, it can be 30% by mass or more and 95% by mass or less of the mass of the ISM.

### Polymer

The ISM 1002 of the embodiment includes the polymer 2002. Among the components included in the ISM 1002, the polymer 2002 is often the second largest in mass ratio after the membrane solvent 2003. The polymer 2002 forms the matrix together with the membrane solvent 2003 and has the function of maintaining the shape as a solid membrane. The polymer 2002 is preferably one with low water solubility in order to form the ISM 1002 in contact with the aqueous solution of the measurement solution 1020 and to form the matrix together with the hydrophobic membrane solvent 2003.

Specific examples of the polymer include at least one selected from the group consisting of an ethylene polymer which may have a substituent, a diene compound polymer, a urethane bond-containing polymer, a siloxane bond-containing polymer, a cellulose derivative, and an organosilicon compound polymer. The ethylene which may have a substituent may be one or more selected from the group consisting of α-olefin, vinyl halide, styrene and its substitutes, acrylic acid ester, methacrylic acid ester, vinyl ester, and the like. Examples of the substituent of the styrene include an alkyl group such as a methyl group, and a halogen atom such as a chloro group. More specifically, examples thereof include polyvinyl chloride, polystyrene, polymethyl acrylate, polymethyl methacrylate, polyvinyl acetate, polybutadiene, polyisoprene, polyacrylonitrile, cellulose acetate, and silicone.

A chain structure of the polymer may be either linear or branched. Among these, a polymer having a three-dimensional mesh structure in which crosslinking groups are introduced can form the matrix of a reinforced hydrophobic membrane for the ISM together with the membrane solvent. This matrix of the reinforced hydrophobic membrane is advantageous in that it forms a hydrophobic membrane that is less affected by the surfactant function of protein.

### Ionophore

The ISM 1002 of the present embodiment includes the ionophore 2001. The ionophore 2001 is a compound that enables generation of an ion-selective membrane potential by selectively taking in the target ion 2005 from the measurement solution 1020 into the ISM 1002.

The ionophore in the present embodiment is a metal porphyrin complex. There are three types of chloride ion ionophores known: organometallic, organic, and metal complex. Among these, the organometallic type is harmful, while the organic type has low ion selectivity, which are problems for practical use. Porphyrin complexes, known as the metal complex type, are less subject to regulation as chemical substances and easier to use than the organometallic type.

A central metal of a metal porphyrin as an ionophore is not particularly limited, but examples thereof include metal elements of group 13, manganese, cobalt, and tin. Among the group 13 elements, aluminum functions as an ionophore for fluoride ions, gallium functions as an ionophore for chloride ions and bromide ions, indium functions as an ionophore for chloride ions, and thallium functions as an ionophore for chloride ions, bromide ions, and iodide ions, respectively. Manganese functions as an ionophore for chloride ions, tin functions as an ionophore for salicylic acid, and cobalt functions as an ionophore for nitrous acid and thiocyanic acid. Among these, thallium complexes and indium complexes are useful as ionophores for chloride ions, which have a wide range of uses. In particular, thallium complexes are advantageous in that they are less harmful than indium complexes, are less subject to regulation as chemical substances, and easier to use.

The porphyrin, which is a ligand of the metal porphyrin, is not particularly limited, but examples thereof include porphyrins having a substituent. Examples of the substituent include an aryl group such as a phenyl group, a saturated or unsaturated alkyl group, an alkoxy group, an alkylcarbonyl group, an alkyloxycarbonyl group, an alkylcarbonyloxy group, an aryloxy group, an aralkyl group, and a halogen atom. Among these substituents, examples of each of the carbon atoms of the alkyl group and the alkoxy group includes 1 or more and 20 or less, examples of each of the carbon atoms of the alkylcarbonyl group, the alkyloxycarbonyl group, and the alkylcarbonyloxy group include 2 or more and 20 or less, examples of each of the carbon atoms of the aryl group and the aryloxy group include 6 or more and 20 or less, and examples of the carbon atoms of the aralkyl group include 7 or more and 30 or less.

Porphyrins having hydrophobic groups as substituents are preferred as ionophores that are isolated from aqueous solutions and retained in hydrophobic matrices. Specific examples thereof include tetraphenylporphyrin and its derivatives, and octaalkylporphyrin and its derivatives.

Examples of the derivatives of tetraphenylporphyrin include compounds having a substituent on any of the phenyl groups bonded to the porphyrin. Examples of the substituent on the phenyl group include a substituent selected from the group consisting of a saturated or unsaturated alkyl group having 1 or more and 20 or less carbon atoms, an alkoxy group having 1 or more and 20 or less carbon atoms, an alkylcarbonyl group having 2 or more and 20 or less carbon atoms, an alkyloxycarbonyl group having 2 or more and 20 or less carbon atoms, an alkylcarbonyloxy group having 2 or more and 20 or less carbon atoms, an aryl group having 6 or more and 20 or less carbon atoms, a cyano group, and a halogen atom.

Examples of the derivatives of octaalkylporphyrin include compounds having a substituent on any of the alkyl groups bonded to the porphyrin. Examples of the substituents on the alkyl group include a substituent selected from the group consisting of an alkoxy group having 1 or more and 4 or less carbon atoms, an alkylcarbonyl group having 2 or more and 5 or less carbon atoms, an alkyloxycarbonyl group having 2 or more and 5 or less carbon atoms, an alkylcarbonyloxy group having 2 or more and 5 or less carbon atoms, an aryl group having 6 or more and 20 or less carbon atoms, a cyano group, and a halogen atom.

The composition ratio of the metal porphyrin in the ISM of the present embodiment can be appropriately selected depending on the use of the ISM. As an example, 0.1 mass % or more and 20 mass % or less of the mass of the ISM can be exemplified. 0.5 mass % or more and 10 mass % or less can be preferably exemplified. If the composition ratio of the metal porphyrin is lower than 0.1 mass %, the electromotive force response to the target ion may decrease. On the other hand, if the composition ratio of the metal porphyrin is higher than 20 mass %, the metal porphyrin may precipitate and hinder intake of the target ion into the membrane.

The ISM of the present embodiment uses a metal porphyrin complex as an ionophore, and thus exhibits high selectivity for various anions, particularly halide ions, especially chloride ions. Specifically, it exhibits high selectivity for hydrogen carbonate ions, phosphate ions, nitrate ions, or the like, which are interfering ions present in biological fluids such as blood and urine. Accordingly, by using the ISM of the present embodiment, the ISE that has high selectivity for anions such as halide ions particularly starting from chloride ions can be formed. The ISM of the present embodiment may be a halide ion-selective membrane such as a chloride ion-selective membrane.

### Ionic Additive

The ISM of the present embodiment may contain an ionic additive. The ionic additive is said to have the effect of preventing intrusion of impurity ions into the membrane, which hinder detection of the target ion. For the metal porphyrin, an ionic additive consisting of a hydrophilic cation and a hydrophobic anion is preferably used. For the hydrophobic anion, a publicly known one can be used. Here, methods for confirming hydrophobicity include a method for confirming whether or not the compound is insoluble in water when a counter cation of the anion is tetrabutylammonium ions.

Examples of the compound having the hydrophobic anion include a tetraphenyl borate compound, a long-chain alkyl sulfonic acid compound, a long-chain dialkyl sulfosuccinic acid compound, a long-chain alkyl phosphate compound, a long-chain dialkyl phosphate compound, and a long-chain dialkyl phosphosuccinic acid compound. Specific examples of the tetraphenyl borate compound include tetrakis[3,5-bis(trifluoromethyl)phenyl]borate (TFPB), tetrakis(4-chlorophenyl)borate, tetrakis(4-fluorophenyl)borate, tetraphenylborate, and the like. Specific examples of the long-chain alkyl sulfonic acid compound include decyl sulfonic acid, dodecyl sulfonic acid, dodecyl benzene sulfonic acid, octadecyl sulfonic acid, oleyl sulfonic acid, and the like. Specific examples of the long-chain dialkyl sulfosuccinic acid include bismethylhexyl sulfosuccinic acid, dioctyl sulfosuccinic acid, didecyl sulfosuccinic acid, didodecyl sulfosuccinic acid, and the like. Specific examples of the long-chain alkyl phosphate compound include decyl phosphonic acid, dodecyl phosphonic acid, dodecyl benzene phosphonic acid, octadecyl phosphonic acid, oleyl phosphonic acid, and the like. Specific examples of the long-chain dialkyl phosphate compound include bismethylhexyl phosphonic acid, dioctyl phosphonic acid, didecyl phosphonic acid, didodecyl phosphonic acid, and the like. Specific examples of the long-chain dialkyl phosphosuccinic acid compound include bismethylhexyl phosphosuccinic acid, dioctyl phosphosuccinic acid, didecyl phosphosuccinic acid, didodecyl phosphosuccinic acid, and the like.

For the cation of the ionic additive, a hydrophilic cation is used. Here, methods for confirming hydrophilicity include a method for confirming whether or not the compound is soluble in water when a counter anion of the cation is hexafluorophosphate ions. For such a cation, a publicly known one can be used. Specifically, alkali metal ions, alkaline earth metal ions, ammonium ions, or the like can be used. More specifically, sodium ions, potassium ions, ammonium ions, or the like can be used.

The composition ratio of the ionic additive to the metal porphyrin in the ISM of the present embodiment can be appropriately selected depending on the use of the ISM. For example, the range of 1 to 100 mol % in terms of a molecular number ratio to the metal porphyrin can be cited. If an amount of the ionic additive added is less than 1 mol %, the electromotive force response to ions may be slow. On the other hand, if the amount of the ionic additive added is more than 100 mol %, the function as a cation exchanger may be more strongly exhibited than the function of electromotive force response to anions, and the electromotive force response to cations may occur. A more preferred concentration of the ionic additive for the metal porphyrin is in the range of 10 to 50 mol %.

In a typical anion-selective electrode (for example, bisthiourea), a combination of a hydrophobic cation and a hydrophilic anion is often selected as the ionic additive. In metal porphyrin, a combination of a hydrophilic cation and a hydrophobic anion is preferably used. This is thought to be because the ion selectivity as an ionophore is activated due to the interaction between the hydrophobic anion and the metal porphyrin.

### Ion Sensor

The present embodiment provides the ion sensor including the ion-selective electrode of the present embodiment, the reference electrode, and a measurement device. The measurement device measures the potential difference between the ion-selective electrode and the reference electrode.

The ion sensor is a sensor that measures a concentration of the target ion contained in a sample. FIG. 4 is a schematic diagram for illustrating an overview of an ion sensor 3050 (ion concentration measurement device) using the ISE 1000 provided with the ISM 1002 according to the present embodiment. In FIG. 3, the ISE 1000 is disposed in contact awith the measurement solution 1020 together with the reference electrode 1010 serving as the comparison target. The reference electrode 1010 may be in contact with the measurement solution 1020 through a salt bridge or liquid junction. A membrane potential (E_{M}) proportional to a logarithm of the concentration (more precisely, the activity a_{I}(aq)) of the target ion in the measurement solution 1020 is generated in the ISM 1002 in contact with the measurement solution 1020 (The above-described Nernst equation).

The ion sensor 3050 measures the potential difference between the ISM 1002 and the reference electrode 1010 with a measurement device 1030 such as a voltmeter for a solution with a known concentration of the target ion and the measurement solution 1020 to calculate the concentration of the target ion in the measurement solution 1020. The above-described reference electrode is preferably used for the reference electrode 1010. A general measurement device can be used for the measurement device 1030. For example, a voltmeter with a large input resistance or a potentiostat in electrometer mode can be used. The input resistance is preferably 10⁹Ω, and more preferably 10¹²Ω or more.

### Specimen Testing Device

The present embodiment provides a specimen testing device provided with the ion-selective electrode of the present embodiment and a mechanism for supplying a specimen to the ion-selective electrode.

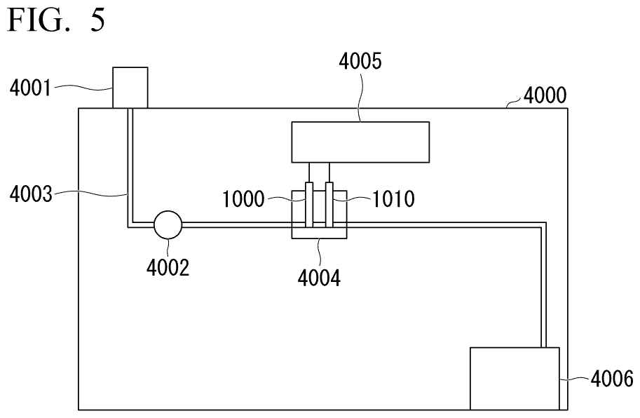

An example of the specimen testing device of the present embodiment will be described with reference to FIG. 5. A specimen testing device 4000 takes in a specimen from a specimen inlet 4001 into a flow path 4003 or the like in the device. The specimen that has been taken in is supplied to the ISE 1000 and the reference electrode 1010 in an ISE unit 4004 through the flow path 4003 or the like by the power of a pump 4002 or the like. An electromotive force generated in the ISE 1000 is measured and recorded by a measurement unit 4005. The specimen sample used in the measurement is collected in a collection container 4006. In addition to the above, the specimen testing device 4000 may also include a unit that supplies and mixes a liquid to dilute the specimen sample, a unit that measures other test items, or the like. The specimen testing device 4000 of the present embodiment can perform analysis of anions such as chloride ions with high accuracy by using the ISE that uses the metal porphyrin as the ionophore.

### Effects and Uses

The ISM of the present embodiment uses the metal porphyrin as the ionophore, and the compound that satisfies CLogP≥9 and is represented by the above general formula (1) as the membrane solvent. As a result, even when the ISM is brought into contact with an aqueous solution containing protein, it is possible to inhibit a decrease in electromotive force response to the ion concentration. As a result, the ISE and the ion sensor with improved protein resistance can be realized. The ion sensor using this ISE with high protein resistance has improved durability as an ion sensor for test subjects containing protein, especially those relating to living organisms. As a result, the specimen testing device using this can test the concentration of the target ion and the specimen for a long period of time.

### EXAMPLES

The present embodiment will be described in more detail below with reference to examples, but the present invention is not limited to these examples.

### (1) Synthesis of Metal Porphyrin

As a compound of examples, the metal porphyrin represented by P-1 in the following reaction formula was synthesized via the reaction shown in the following formula (A) with reference to a non-patent document (Polyhedron, 1986, Vol. 5, pp. 1157-1164).

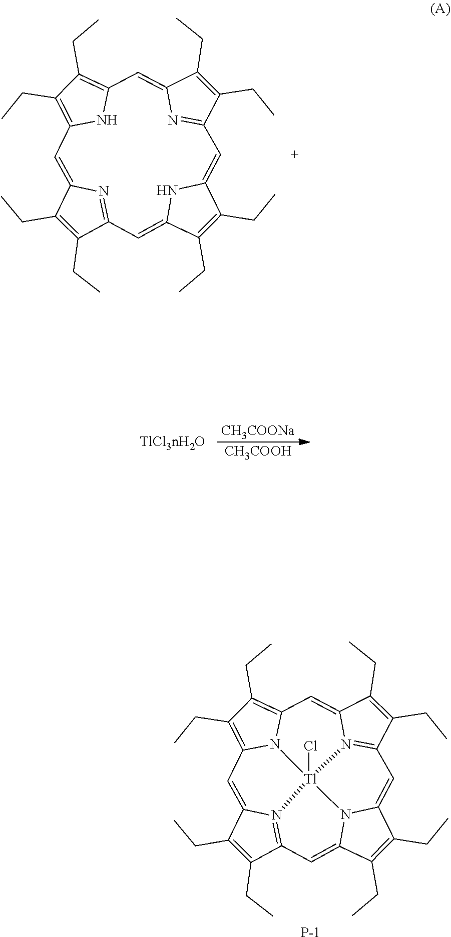

### (2) Preparation of ISMs

Methods for preparing ISMs used in the examples and comparative examples will be described. The following materials were used for these ISMs. As membrane solvents of the examples, bis(2-ethylhexyl) isophthalate (DOIP), bis(2-ethylhexyl) terephthalate (DOTP), and tetra(2-ethylhexyl) pyromellitic acid (TOP) were used. As membrane solvents of the comparative examples, 2-nitrophenyl octyl ether (NPOE) and bis(2-ethylhexyl) phthalate (DOP) were used. The CLogP of each membrane solvent was calculated using commercially available software (ChemDraw). The 2-ethylhexyl group is an alkyl group with 8 carbon atoms.

In both the examples and comparative examples, polyvinyl chloride (PVC) or cross-linked PVC (CL-PVC) was used as the polymer, metal porphyrin compound P-1 was used as the ionophore, sodium tetrakis[3,5-bis(trifluoromethyl)phenyl]borate (NaTFPB) was used as the ionic additive, and tetrahydrofuran (THF) was used as the process solvent. The membrane solvent, the PVC, the metal porphyrin, and the NaTFPB were dissolved in the THF by heating, cast on a glass plate, and the THF was evaporated to prepare the ISM. A mass ratio in a representative membrane was set to membrane solvent/PVC/metal porphyrin=66/33/1. A concentration of the ionic additive was 5.6 mol % in terms of molecular number ratio to the metal porphyrin. The prepared ISM had a thickness of approximately 0.4 mm.

### (3) Preparation of ISEs

Methods for producing ISEs used in the examples and comparative examples will be described. The ISMs were cut to match electrode sizes and attached to PVC electrode cases with the THF. The ISMs were conditioned overnight with a 10 mM NaCl aqueous solution, and then disposed between the silver/silver chloride (Ag/AgCl) electrode and the sample solution via an internal solution consisting of a 10 mM NaCl aqueous solution, as shown in FIG. 1.

### (4) Evaluation

### Electromotive Force Evaluation

The ISE and the reference electrode (Ag/AgCl) were connected to a potentiostat with an input resistance of 10¹²Ω as shown in FIG. 1, the electromotive force (EMF) was measured when a Cl ion concentration in tris(hydroxymethyl)aminomethane (Tris)-acetate buffer was changed, and a slope of the electromotive force against a logarithm of the Cl ion concentration was calculated in the range of 1.8 to 7.1 mM. The measurements were performed at 23° C.

### Protein Resistance Evaluation

The above-mentioned electromotive force evaluation was performed before and after immersing the ISE in Tris-acetate buffer containing bovine serum albumin (BSA) for 3 minutes for 8 cycles. A ratio of the slope of the electromotive force to the logarithm of the Cl ion concentration (after immersion/before immersion) was calculated to evaluate the protein resistance.

### (5) Results

Table 1 shows the CLogP of each membrane solvent included in the ISM, an initial slope (sensitivity) of the ISE using the ISM, and a ratio of the initial slope to the slope after the protein resistance evaluation (slope ratio). From Table 1, it has been found that the CLogP of the membrane solvents of the examples shows a value of 9 or more. In contrast, it has been found that the CLogP of the membrane solvents of the comparative examples shows a value of less than 9. In the ISE, the EMF changes linearly with the logarithm of the target ion concentration, and the slope is the sensitivity to the target ion. In addition, in the case of an anion ISE, the slope is negative. From Table 1, initial slope values obtained for both the membrane solvents of the examples and the membrane solvents of the comparative examples were negative values smaller than −40 mV dec⁻¹ (a change in EMF (in mV units) when the concentration changes by one digit). After immersing the ISE in the BSA-added buffer solution, the electromotive force was evaluated, and the calculated slope ratios (after immersion/before immersion) were 0.6 or more for the membrane solvents of the examples. In contrast, the slope ratios of the comparative examples were less than 0.6.

Table 1 is a list of the CLogP of the membrane solvents of the examples and the comparative examples, and the initial EMF response (initial slope) of the ISE using them and the EMF response (slope ratio) after the protein resistance evaluation.

TABLE 1

| | | | | Slope ratio (before and |
|---|---|---|---|---|
| | Membrane | | Initial slope | after protein resistance |
| | solvent | CLogP | mV dec⁻¹ | evaluation) |
| Example 1 | DOIP | 9.14 | −51.5 | 0.68 |
| Example 2 | DOTP | 9.23 | −47.8 | 0.64 |
| Example 3 | TOP | 15.3 | −44.0 | 0.83 |
| Comparative | NPOE | 5.04 | −49.2 | 0.21 |
| Example 1 | | | | |
| Comparative | DOP | 8.71 | −41.4 | 0.42 |
| Example 2 | | | | |

Table 2 is a list of the CLogP of the membrane solvents of the examples and the initial EMF response of the ISE using CL-PVC together with them and the EMF response after the protein resistance evaluation.

TABLE 2

| | | | | Slope ratio (before and |
|---|---|---|---|---|
| | Membrane | | Initial slope | after protein resistance |
| | solvent | CLogP | mV dec⁻¹ | evaluation) |
| Example 4 | DOIP | 9.14 | −50.1 | 0.79 |
| Example 5 | TOP | 15.3 | −45.9 | 0.88 |

### (6) Discussion

It can be seen that the CLogP of the membrane solvents used in the ISMs of the examples was 9 or more, and they were more hydrophobic than the membrane solvents used in the ISMs of the comparative examples. In particular, the TOP with a large number of alkyl chains showed a high CLogP value. The initial slope value was sufficient for measuring the ion concentration in both the ISEs using the membrane solvents of the examples and the comparative examples. In contrast, the slope ratio (after immersion/before immersion), which is an evaluation parameter for protein resistance, was high in the ISEs using the membrane solvents of the examples and low in the ISEs using the membrane solvents of the comparative examples. From this, it was found that the ISMs using the membrane solvents of the examples showed high protein resistance. This is thought to be because the cause of the decrease in electromotive force response due to the influence of protein is the unclear hydrophobic membrane/aqueous solution interface due to the surfactant function of protein, and by improving the hydrophobicity of the membrane solvent, a hydrophobic membrane that can inhibit the influence of the surfactant function of protein can be formed.

The DOIP and the DOTP of the membrane solvent used in the ISMs of Examples 1 and 2 have a molecular structure in which two ester groups are disposed at a distance from each other as compared to the molecular structure of the DOP of the membrane solvent used in the ISM of Comparative Example 2. This is thought to have strengthened the hydrophobic interactions between molecules in the ISMs of Examples 1 and 2, and thus a hydrophobic membrane that inhibits the effects of the surfactant function of protein can be formed.

The TOP of the membrane solvent used in the ISM of Example 3 has four hydrophobic ester groups in its molecule. This is thought to be the reason that the ISM of Example 3 was able to form the hydrophobic membrane that inhibited the effects of the surfactant function of protein, and thus exhibits the highest protein resistance.

The polymer CL-PVC used in the ISMs of Examples 4 and 5 has a three-dimensional mesh structure in which crosslinking groups have been introduced into the PVC chain. This is thought to be the reason that the matrix of the hydrophobic membrane made of the membrane solvent and the polymer was strengthened in the ISMs of Examples 4 and 5 as compared to the chain-structured PVC, and the hydrophobic membrane that inhibited the effects of the surfactant function of protein.

### (6) Summary

The following has been found from the examples in the ISM containing the metal porphyrin compound, the polymer, and the membrane solvent consisting of the aromatic alkyl ester compound.
By using the compound with a CLogP of 9 or more as the membrane solvent, the ISM in which the influence of protein is inhibited can be provided.
By using the compound in which alkyl ester groups are bonded to two or more non-adjacent carbons of a benzene ring as the membrane solvent, the ISM in which the influence of protein is inhibited can be provided.
By using the compound in which four alkyl ester groups are bonded to the membrane solvent, the ISM in which the influence of protein is inhibited can be provided.
By using the polymer with a cross-linked structure as the polymer, the ISM in which the influence of protein is inhibited can be provided.

It has been shown that these findings can improve the value of devices using ISEs, such as ion sensors and specimen testing devices.

According to at least one of the embodiments described above, by including the compound that satisfies CLogP≥9 and is represented by the above general formula (1) as a membrane solvent, the influence of protein on an ISM using a metal porphyrin complex as an ionophore can be inhibited.

Several embodiments of the present invention have been described, but these embodiments are presented as examples and are not intended to limit the scope of the invention. These embodiments may be implemented in a variety of other forms, and various omissions, substitutions, and modifications may be made without departing from the gist of the invention. These embodiments and their modifications are included in the scope of the invention and its equivalents as set forth in the claims, as well as the scope and gist of the invention.

What is claimed is:

1. An ion-selective membrane comprising a metal porphyrin compound, a polymer and a membrane solvent, the membrane solvent satisfying CLogP≥9 and including a compound represented by the following general formula (1), 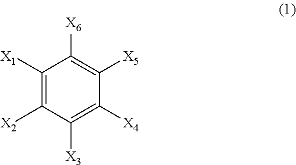
wherein in the general formula (1),
X₁ is an alkyl ester group having 5 or more and 19 or less carbon atoms which may have a substituent,
X₂ to X₆ are each independently a hydrogen atom or a monovalent substituent, and
at least one of X₃, X₄, and X₅ is an alkyl ester group having 5 or more and 19 or less carbon atoms which may have the substituent.

2. The ion-selective membrane according to claim 1,
wherein in the general formula (1),
X₁ is an alkyl ester group having 7 or more and 13 or less carbon atoms which may have a substituent, and
at least one of X₃, X₄, and X₅ is an alkyl ester group having 7 or more and 13 or less carbon atoms which may have the substituent.

3. The ion-selective membrane according to claim 1,
wherein in the general formula (1),
X₂ to X₆ are each independently a hydrogen atom, a saturated or unsaturated alkyl group having 1 or more and 20 or less carbon atoms which may have a substituent, an alkoxy group having 1 or more and 20 or less carbon atoms which may have a substituent, an alkylcarbonyl group having 2 or more and 20 or less carbon atoms which may have a substituent, an aryl group having 6 or more and 20 or less carbon atoms which may have a substituent, an aryloxy group having 6 or more and 20 or less carbon atoms which may have a substituent, an aralkyl group having 7 or more and 30 or less carbon atoms which may have a substituent, a halogen atom, or an alkyl ester group having 5 or more and 19 or less carbon atoms which may have the substituent.

4. The ion-selective membrane according to claim 3,
wherein the substituent of the alkyl group is selected from the group consisting of an alkoxy group having 1 or more and 4 or less carbon atoms, an alkylcarbonyl group having 2 or more and 5 or less carbon atoms, an alkyloxycarbonyl group having 2 or more and 5 or less carbon atoms, an alkylcarbonyloxy group having 2 or more and 5 or less carbon atoms, an aryl group having 6 or more and 20 or less carbon atoms, a cyano group, and a halogen atom,
the substituents of the alkoxy group, the alkylcarbonyl group, the aryl group, the aryloxy group, and the aralkyl group are selected from the group consisting of a saturated or unsaturated alkyl group having 1 or more and 20 or less carbon atoms, an alkoxy group having 1 or more and 20 or less carbon atoms, an alkylcarbonyl group having 2 or more and 20 or less carbon atoms, an alkyloxycarbonyl group having 2 or more and 20 or less carbon atoms, an alkylcarbonyloxy group having 2 or more and 20 or less carbon atoms, an aryl group having 6 or more and 20 or less carbon atoms, a cyano group, and a halogen atom, and
the substituent of the alkyl ester group having 5 or more and 19 or less carbon atoms which may have the substituent is selected from the group consisting of an alkoxy group having 1 or more and 4 or less carbon atoms, an alkylcarbonyl group having 2 or more and 5 or less carbon atoms, an alkyloxycarbonyl group having 2 or more and 5 or less carbon atoms, an alkylcarbonyloxy group having 2 or more and 5 or less carbon atoms, an aryl group having 6 or more and 20 or less carbon atoms, a cyano group, and a halogen atom.

5. The ion-selective membrane according to claim 1,
wherein the membrane solvent contains a compound represented by any of the following general formulas (2), (3), and (4), 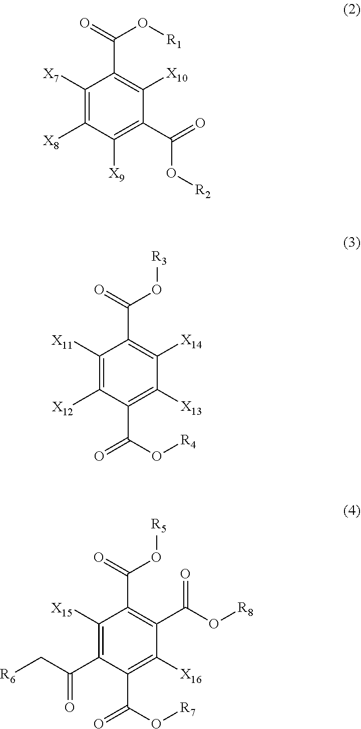
in the general formulas (2), (3), and (4),
X₇ to X₁₆ are each independently a hydrogen atom or a substituent of which a hydrophobicity constant 7c of aromatic substituent is 0 or more,
R₁ to R₈ are each independently an alkyl group having 4 or more and 18 or less carbon atoms which may have a substituent, and
the substituents in R₁ to R₈ are each independently a substituent of the alkyl ester group.

6. The ion-selective membrane according to claim 1,
wherein the compound represented by the general formula (1) is bis(2-ethylhexyl) isophthalate (DOIP), bis(2-ethylhexyl) terephthalate (DOTP), tetra(2-ethylhexyl) pyromellitic acid (TOP), or a mixture of two or more of these.

7. The ion-selective membrane according to claim 1, wherein the polymer is a polymer having a cross-linked structure.

8. The ion-selective membrane according to claim 1, wherein the ion-selective membrane is a chloride ion-selective membrane.

9. The ion-selective membrane according to claim 1, further comprising an ionic additive.

10. The ion-selective membrane according to claim 9, wherein the ionic additive is configured of a hydrophilic cation and a hydrophobic anion.

11. An ion-selective electrode comprising the ion-selective membrane according to claim 1 applied to an electrode configured of at least one type of conductor.

12. An ion sensor comprising the ion-selective electrode according to claim 11, a reference electrode, and a measurement device configured to measure a potential difference between the ion-selective electrode and the reference electrode.

13. A specimen testing device comprising the ion-selective electrode according to claim 11 and a mechanism for supplying a specimen to the ion-selective electrode.

14. The ion-selective membrane according to claim 1,
wherein the polymer is at least one selected from the group consisting of an ethylene polymer which may have a substituent, a polymer of a diene compound, a polymer having a urethane bond, a polymer having a siloxane bond, a cellulose derivative, and a polymer of an organosilicon compound.
